(19) United States
(12) Patent Application Publication
(10) Pub. No.: US 2013/0346414 A1
(43) Pub. Date: Dec. 26, 2013

(54) Correlation Engine and Method for Granular Meta-Content Having Arbitrary Non-Uniform Granularity

(71) Applicants: Alfonso Martinez Smith, Algonquin, IL (US); Paul C. Davis, Arlington Heights, IL (US); Joshua B. Hurwitz, Niles, IL (US); Douglas A. Kuhlman, Inverness, IL (US); Hiren M. Mandalia, Elk Grove Village, IL (US); Loren J. Rittle, Lake Zurich, IL (US); Krunal S. Shah, Chicago, IL (US)

(72) Inventors: Alfonso Martinez Smith, Algonquin, IL (US); Paul C. Davis, Arlington Heights, IL (US); Joshua B. Hurwitz, Niles, IL (US); Douglas A. Kuhlman, Inverness, IL (US); Hiren M. Mandalia, Elk Grove Village, IL (US); Loren J. Rittle, Lake Zurich, IL (US); Krunal S. Shah, Chicago, IL (US)

(73) Assignee: General Instrument Corporation, Horsham, PA (US)

(21) Appl. No.: 13/528,917

(22) Filed: Jun. 21, 2012

(51) Int. Cl. G06F 17/30

(52) U.S. Cl. 707/741; 707/736; 707/E17.002

(57) ABSTRACT

One disclosed method includes receiving correlation instructions related to a plurality of meta-content elements that are associated with a primary content. The primary content may be multimedia content such as, but not limited to, an audiovisual content. The method includes performing a correlation in response to receiving the instructions. The correlation is between the meta-content elements, where the meta-content elements each have an arbitrary granularity defining meta-content segments. The method returns a result based on the correlation. Another disclosed method include receiving a request having correlation instructions related to a plurality of meta-content elements, where the meta-content elements are associated with a primary content. Again, each meta-content element has an arbitrary granularity defining meta-content segments. The method includes determining, in response to receiving the request, a composite of meta-content segments of the plurality of meta-content elements, based on the correlation instructions.

### CROSS-REFERENCE TO RELATED APPLICATIONS

The present disclosure is related to copending U.S. patent application Ser. No. nn/nnn,nnn “CONTENT RIGHTS PROTECTION WITH ARBITRARY CORRELATION OF SECOND CONTENT,” Attorney Docket No. CS39043; and copending U.S patent application Ser. No. nn/nnn,nnn, “PRIVACY MANAGER FOR RESTRICTING CORRELATION OF META-CONTENT HAVING PROTECTED INFORMATION BASED ON PRIVACY RULES,” Attorney Docket No. CS40207; both of which are assigned to the same assignee as the present application, and both are hereby incorporated by reference herein in their entirety.

### FIELD OF THE DISCLOSURE

The present disclosure relates generally to content metadata, or meta-content, and accessing and utilizing metadata or meta-content.

### BACKGROUND

Content, and the various types or forms of content that have been developed, has ushered in the use of associated data commonly referred to as metadata. The development of metadata has itself evolved into an array of metadata types and forms. In its earliest manifestation, metadata provided basic information associated with the content. For example, a photograph might have associated metadata for providing the time the photograph was taken, the particular camera and camera settings used to take the photograph, and even information identifying the copyright holder. As metadata has evolved, the amount of information that can be stored in association with content may be viewed as another form of content itself, i.e. a “meta-content,” in that the meta-content may exist separately from the content and take on an independent purpose of its own. In other words, meta-content may exist independently from its associated “primary” content. Although the term “meta-content” may appear to blur the demarcation between content as a form of data, and metadata, the term “meta-content” should be understood as referring to secondary content that provides information about a primary content or, alternatively, secondary content that is associated with a primary content. For example, search engines may use meta-content to enable producing search results for a wide range of criteria related to a primary content. Alternatively, meta-content may include information relating to a study or analysis of the primary content.

Given the wide variety of meta-content that may exist in relation to any given primary content, accessing and managing the meta-content has become proportionately difficult. Even given the available technology, some processes involving meta-content are still performed in a somewhat manual fashion. For example, creating primary content, or secondary content related to primary content, such as news videos, montages, etc., often still requires sorting through various forms of meta-content in order to obtain desirable meta-content segments. Various other uses of meta-content can be equally daunting.

In an example context of current video distribution systems, each instance of an audiovisual content (i.e. a “primary” content), is often associated with a unique program identifier which is a form a catalog metadata associated with the primary content. Such catalog metadata is commonly defined at a top-most level. In other words, catalog metadata descriptors are often associated only with one particular instance of an audiovisual content.

Primary content may have various related secondary content, i.e. meta-content such as, associated video clips, voice-overs and/or independent sections such as headlines, local news, international news, sports, weather, entertainment, etc. which are not independently identifiable. As a result, such meta-content is not open to independent descriptor annotation using traditional catalog metadata frameworks. Additionally, an audiovisual content may have more than one type of parallel catalog metadata stream.

Examples of this include simultaneous streams for textual description of the primary content (such as mentioned briefly above, where title, associated video clips, and voice-overs describe each section), scene segmentation based on audiovisual signal processing and scene boundary detection, parallel feed insertion where specific sections are associated with secondary content to be associated exclusively with that particular section), key frame extraction with automatic storyboarding, and others. Naturally, this is not restricted to television newscasts but applies to various primary content such as, but not limited to, movie productions, sports broadcasts, and many other audiovisual content categories.

### BRIEF DESCRIPTION OF THE DRAWINGS

FIG. 1 is a block diagram of a system architecture that includes a correlation engine in accordance with the embodiments.

FIG. 2 is a block diagram illustrating the relationship of content to various granular meta-content elements where each meta-content elements granularity defines meta-content segments and items.

FIG. 3 is a block diagram of a system architecture in accordance with some embodiments where a stream handler includes a correlation engine.

FIG. 4 is a block diagram providing details of a system architecture 400 example having a correlation engine within a network having a distributed file system, in accordance with an embodiment.

FIG. 5 is a flow chart diagram illustrating an example high level operation of a correlation engine in accordance with the various embodiments.

FIG. 6 is flow chart diagram illustrating an example high level operation of a correlation engine in accordance with the various embodiments, where the correlation engine receives correlation instructions along with information identifying a primary content.

FIG. 7 is a flow chart diagram illustrating an example high level operation of a correlation engine in accordance with the various embodiments, where the correlation engine receives correlation instructions along with information identifying a primary content and information identifying a set of meta-content elements.

FIG. 8 is a flow chart diagram illustrating an example high level operation of a correlation engine in accordance with the various embodiments, where the correlation engine receives correlation instructions along with information identifying a set of meta-content elements, and returns the identity of the primary content.

FIG. 9 is a detailed example of the determine step as shown in FIG. 5, 513; FIG. 6, 609; FIG. 7, 711 and FIG. 8, 809, when the correlation instructions involve a time-related information aggregation including video, audio and closed caption analysis results merged and ordered in time.

FIG. 10 is a detailed example of the determine step as shown in FIG. 5, 513; FIG. 6, 609; FIG. 7, 711 and FIG. 8, 809, when the correlation instructions involve locating video event sequences including flash frame, logo and black frame in a specified order, and audio events including a station-identifier musical signature.

FIG. 11 is a detailed example of the determine step as shown in FIG. 5, 513; FIG. 6, 609; FIG. 7, 711 and FIG. 8, 809, when the correlation instructions involve identifying closed caption text having the words “stop, police” near in time to audio analysis results containing gunshots, related to drama television shows.

FIG. 12 is a detailed example of the determine step as shown in FIG. 5, 513; FIG. 6, 609; FIG. 7, 711 and FIG. 8, 809, when the correlation instructions involve closed caption analysis results related to news casts and containing the phrase “election results.”

FIG. 13 is a detailed example of the determine step as shown in FIG. 5, 513; FIG. 6, 609; FIG. 7, 711 and FIG. 8, 809, when the correlation instructions involve construction of a heat-map against either simple counts or complex aggregated statistics of meta-content items within a conjoint grouping of meta-content elements.

### DETAILED DESCRIPTION

The present disclosure provides a method and apparatus for correlating meta-content elements having arbitrary granularity and/or arbitrary indexing schemes. A wide array of applications is made possible and enabled by the correlation of such meta-content elements which creates an associated normalized index to enable extraction of various forms of analytical information and creation of new semantic relationships between meta-content elements.

The disclosed embodiments enable correlation between various types of parallel catalog metadata streams (referred to herein as “meta-content elements”). The embodiments can create correlations between such meta-content elements whether they are created before, during, or after an initial creation/recording (in the cases where the creator or distributor provides the catalog metadata) or a particular viewing (in the cases where a viewer or other source either directly or indirectly generates the catalog metadata). In addition, relationships at different semantic levels may be established by cross-referencing the catalog metadata and/or meta-content from several streams pertaining to a particular section of a primary content. These meta-content elements can then be analyzed and exploited to infer further information about specific sections of a primary content, for example an audiovisual content.

One disclosed method includes receiving correlation instructions, by a correlation engine, related to a plurality of meta-content elements where the meta-content elements are associated with a primary content. The correlation engine performs a correlation between the meta-content elements, which may each have an arbitrary granularity defining meta-content segments of the meta-content elements. A result based on the correlation is returned. The result may include a relevant meta-content segment.

The correlation instructions may be sent to the correlation engine via a request from a client application. The correlation engine may adjust arbitrary granularity of each meta-content element to a uniform granularity, prior to performing the correlation. The correlation engine may also normalize an arbitrary index of each meta-content element to create a normalized index, prior to performing the correlation. The normalized index may be a time based index, a location based index, or a context based index.

The requests sent by a client application may include various information such as information identifying the primary content, information identifying a set of meta-content elements associated with the primary content, and/or information identifying a portion of the primary content with indexes according to an established indexing scheme.

Another disclosed method includes receiving a request having correlation instructions related to a plurality of meta-content elements having an arbitrary granularity defining meta-content segments. In response to receiving the correlation instructions, the correlation engine determines a composite of meta-content segments based on the correlation instructions. The method may include the correlation engine adjusting the arbitrary granularity of each meta-content element to a uniform granularity, and normalizing each meta-content element arbitrary indexing scheme to create a normalized index between the plurality of meta-content elements, prior to performing the correlation. The normalization may include normalizing each meta-content element arbitrary indexing scheme to create the normalized index where the normalized index includes at least one of a time based index, a location based index, or a context based index.

Another disclosed method includes receiving a request having correlation instructions related to a plurality of meta-content elements associated with a primary content, with each meta-content element having an arbitrary granularity defining meta-content segments. The method includes performing a correlation between the meta-content elements based on an indexing scheme, where each meta-content element has an arbitrary indexing scheme; and determining an identity of the primary content based on the results of the correlation.

The method may also include adjusting the arbitrary granularity of each meta-content element to a uniform granularity, and normalizing each meta-content element arbitrary indexing scheme to create a normalized index between the plurality of meta-content elements, prior to performing the correlation. The index may be one of a time based index, a location based index, or a context based index.

Another aspect of the disclosure provides an apparatus, with at least one programmable processor, and memory, operatively coupled to the programmable processor. The memory contains executable instructions for execution by the at least one processor, where the at least one processor, upon executing the executable instructions is operable to receive correlation instructions related to a plurality of meta-content elements associated with a primary content; perform a correlation in response to receiving the instructions, and return a result based on the correlation. The aforementioned executable instructions may also be stored by a non-volatile, non-transitory memory that may be loaded to the at least one processor for execution.

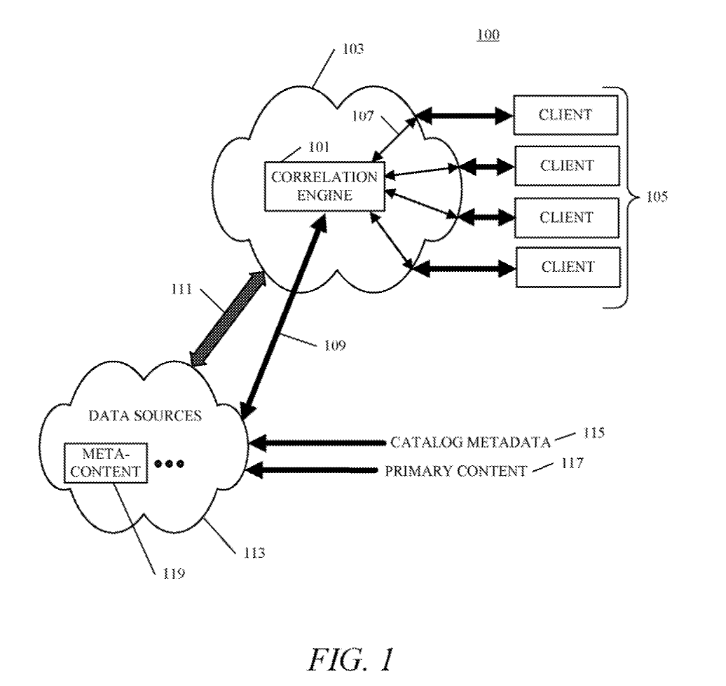

Turning now to the drawings wherein like numerals represent like components, FIG. 1 illustrates a system architecture 100 that includes a correlation engine 101 in accordance with the embodiments. The correlation engine 101 correlates and indexes metadata and/or meta-content in accordance with the embodiments. The correlation engine 101 may be a part of, or contained within, a network 103. The network 103 may be any suitable network however, the network 103 may contain a distributed file system as will be described in further detail below. The network 103 may also contain or be able to communicate with with a variety of data sources 113 via in some cases, another network connection 111. In accordance with the embodiments, the correlation engine 101 is able to access the data sources 113 as shown by the communication path 109. The variety of data sources 113 may provide primary content, and associated metadata and/or meta-content received from a variety of providers. The variety of providers may provide, for example, catalog metadata 115 and various forms of primary content 117 such as, but not limited to video content, audio content, etc. The catalog metadata 115 may be independent metadata and/or meta-content, or may be associated with corresponding pieces of primary content 117. The system architecture 100 shown in FIG. 1 includes a plurality of clients 105 which may be devices having various client applications that may interact with the correlation engine 101 in accordance with the embodiments. The clients 105 may interact with the meta-content elements 119 located in the data sources 113, via the network connection 111, as will be discussed further below.

The term “client” as used herein may refer to an electronic device, such as, for example, a smart phone, laptop, personal digital assistant (PDA), electronic book reader, tablet, personal computer (PC), etc., any of which may employ any suitable network access technology in order to access the network 103. A “client” may also be used herein to refer to a web service, a server, various applications such as, but not limited to, an analysis application, a report generator, or other components within a back-end system, any of which may also employ any suitable network access technology in order to access the network 103. That is, the term “client” as used herein also collectively refers to a “client application” or “application” which may be software running on a processor of an electronic device and which may send a request 107 to the correlation engine 101. For example any one of the clients 105 may send a request 107 to the correlation engine 101 to obtain information related to primary content 117 or of meta-content associated with the primary content 117, and/or to obtain primary content 117, associated meta-content elements 119, catalog metadata 115 or various composites. The correlation engine 101, by the communication path 109, may communicate with the data sources 113 to obtain, as necessary, access to catalog metadata 115 and/or meta-content elements 119. For example, one or more of the clients 105 may be an application that works with various meta-content. One of the clients 105 may include an application that may send a request 107 to correlation engine 101 that includes correlation instructions and that may also provide identification information related to primary content 117 or related to meta-content elements 119 associated with primary content 117. The request 107 may also include catalog metadata 115 as the identification information for either the primary content 117 or the meta-content elements 119. As will be described in further detail below, the correlation engine 101, in accordance with the embodiments, performs a correlation in accordance with the correlation instructions received in the request 107. The correlation engine 101 returns a result which may include meta-content elements, meta-content segments, meta-content items, or composites of any of these, associated with the primary content. The correlation engine 101 may also return the identity of a primary content that is related to various meta-content elements, a composite of meta-content elements or a composite of meta-content segments or items as will be described in further detail below. The correlation instructions may be executable code or, in some embodiments, references to executable code, or combinations of both. The executable code may be stored in local memory or remotely, for example, on a server. The executable code may be native code, universal byte code or a script language. For example, in one embodiment, the correlation instructions may be written in Structure Query Language (SQL). In an alternative embodiment, the correlation instructions may contain references to stored SQL procedures. In some embodiments, the correlation instructions may be written in a high-level, domain specific language, and/or may be written in first-order predicate logic.

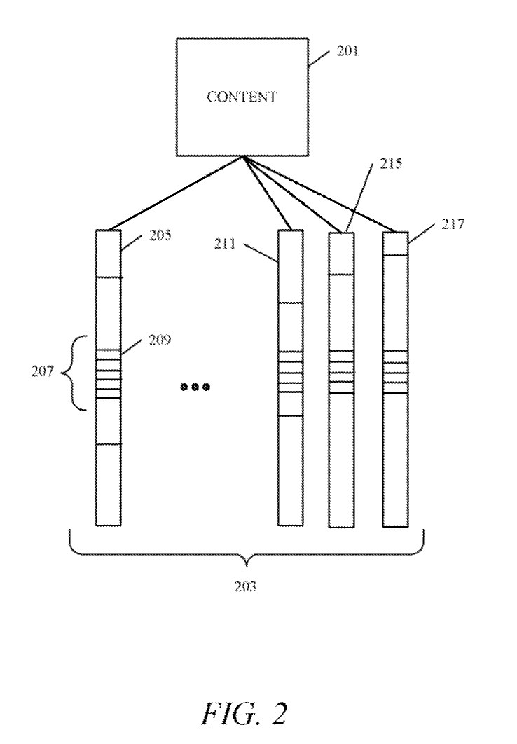

FIG. 2 illustrates the relationship of primary content 201 to associated meta-content elements 203. As shown in FIG. 2 a primary content 201 may be associated with a plurality of meta-content such as meta-content element 205, 211, 215 and 217. Each of the meta-content elements, such as meta-content element 205, has an associated but arbitrary granularity. The granularity of the meta-content elements may be related to segmentation based on intervals of time, location, or any other suitable criteria. As shown in FIG. 2, the meta-content element 205 includes meta-content segment 207 which is further subdivided into meta-content items 209.

The term “meta-content” as used herein may encompass, or include, various types and forms of metadata associated with a piece of content. That is, the term meta-content as used herein may refer to metadata that may be considered content in and of itself. For example, such meta-content may be a multimedia content or other audiovisual content such as a “director's cut” of a movie content, or may be analysis output from a visual detector or some other analysis tool. In other words, meta-content may include other content (i.e. “second” or “secondary” content) that provides, but is not limited to, information, analysis, contextual information, etc., about or related to the main or primary content. Such meta-content may include, but is not limited to, date information, time information, location information, annotations, various properties of the content, keyframes, excitement level, associated Twitter® posts, facial recognition information, optical character recognition, object recognition, speech-to-text or other speech recognition information, closed captioning, analysis of text streams (such as closed captioning) to produce keyterm extraction, named entity recognition, other text analyses, related content, related segments, Twitter® feeds, excitement levels, aggregation of an analysis, summaries, and the like, etc. A “meta-content element” as used herein refers to a piece of meta-content, in any of the various meta-content forms as described above, that may be indexed and searchable using an index scheme. A meta-content element may be subdivided into “meta-content items” when an item corresponds to a “grain” or granularity of the meta-content element. For example, as shown in FIG. 2, a meta-content element 205 may have a time based granularity where a meta-content item 209 may be defined as a time interval in second, milliseconds, etc. As illustrated in FIG. 2, groups of contiguous meta-content items are referred to herein as “meta-content segments” such as meta-content segment 207.

Therefore, in the example provided in FIG. 1, the data sources 113 may provide various form of meta-content elements 119, which may include associated catalog metadata 115, and may include closed captioning information, visual detector analysis data, audio, director's cut video, etc. That is, any particular piece of primary content 117 may have various associated meta-content elements 119, as well as associated catalog metadata 115. Additional meta-content elements may also be created and/or added at any time by the various clients 105 in accordance with the embodiments. The meta-content elements 119, each include granular segments that may be viewed as partitioning the meta-content elements. For example, as shown in FIG. 2, meta-content element 205 has a meta-content segment 207 and granular meta-content items 209. The granular segments may be, in some embodiments, related to periods of time, but are not limited to time. For example, a television news cast may consist of several stories, each of which has its own unique associated meta-content segments. The granular segmentation of the meta-content is arbitrary, in that, the granularity is determined by how the meta-content is generated. For example, a visual detector analysis tool of one of the clients 105, may produce a meta-content element that includes granularity different than that of meta-content element 205. That is, the granularity is non-uniform between or among meta-content elements, and is arbitrary in that it is determined by the method or application that generated the meta-content element.

In accordance with the embodiments, a correlation engine 101 may analyze the granular segments of each meta-content element, of meta-content elements 119, and may create a correlation between various segments and/or items of various meta-content elements 119. The correlation engine 101 may also normalize indexing schemes used by any of the meta-content elements 119, prior to performing a correlation. The correlation engine 101 may also increase, or decrease, the granularity of meta-content element segments and items in order to facilitate index normalization. That is, the correlation engine 101 may perform some level of synchronization and/or alignment of meta-content segmentation. For example, the correlation engine 101 may create a correlation among certain granular segments of meta-content elements 205 and 211. In an example case where the granular segmentation of meta-content elements 205 and 211 are time based, the correlation engine 101 may increase granular segmentation of one, or both, meta-content elements as needed to achieve synchronization. However, correlations between meta-content element segments may be based on various other criteria such as, but not limited to location, context, or other analysis related criteria. For example, the correlation of the meta-content elements may be location related correlations. Among other advantages, the normalization enables forming correlations between meta-content elements at the level of meta-content segments and/or meta-content items.

The system architecture 100 may include various servers and data storage, etc., that are operatively coupled to each other via network connections. For example, the meta-content elements 119 may be stored on a content server or data repository in some embodiments. The correlation engine 101 may also be located on a server and, in some embodiments, may be a distributed function, distributed among several servers. The correlation engine 101 may access the meta-content, via operative coupling providing a communication path 109 between the correlation engine 101 and the meta-content (i.e. to any content server, data repository, etc.) and facilitated by a network or any other suitable connectivity.

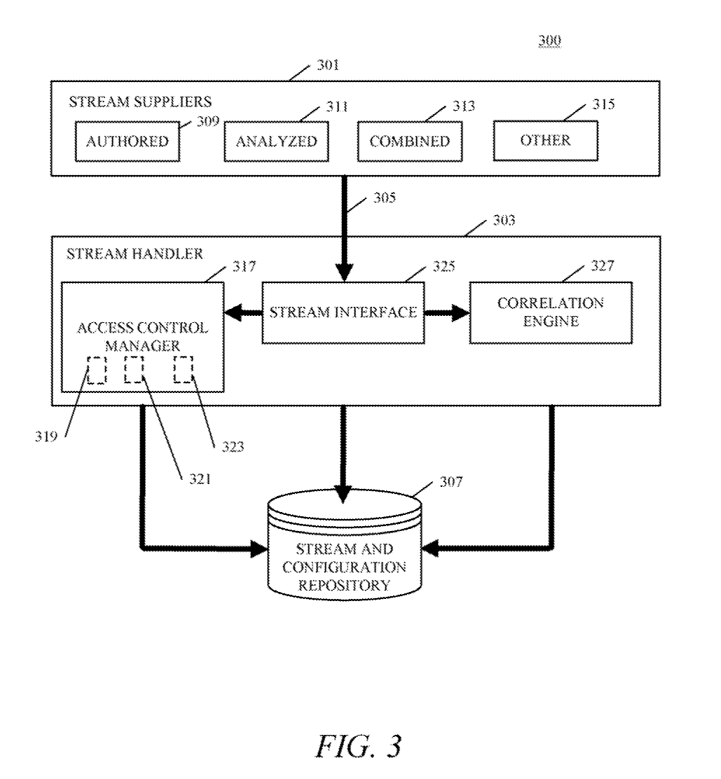

FIG. 3 illustrates example system architecture 300 in accordance with one embodiment. The system architecture 300 enables the annotation, storage, retrieval, and utilization of catalog metadata and/or meta-content elements, in order to enhance the semantic meaning and interpretation of a multiplicity of catalog metadata and/or meta-content elements or streams associated with a primary content, such as, but not limited to an audiovisual content, a textual content, or a video game.

The system architecture 300 includes a plurality of stream suppliers 301 which are operatively coupled via, for example, a network connection 305, to a stream handler 303. The stream suppliers 301 provide various meta-content elements associated with primary content and may include among other things, authored meta-content elements 309 analyzed meta-content elements 311, combined meta-content elements 313 or other meta-content elements 315, all of which may be generated or produced by various associated client applications or tools. The stream handler 303 in accordance with the embodiments includes an access control manager 317 operatively coupled to a stream interface 325 which may restrict access to meta-content elements base on conditional rules, and/or privacy and security requirements. A correlation engine 327 is also operatively coupled to the stream interface 325 and, therefore, either the access control manager 317 or the correlation engine 327 may access meta-content elements from the plurality of stream suppliers 301. The stream handler 303 may also access the stream and configuration repository 307 for storing meta-content elements and metadata as necessary.

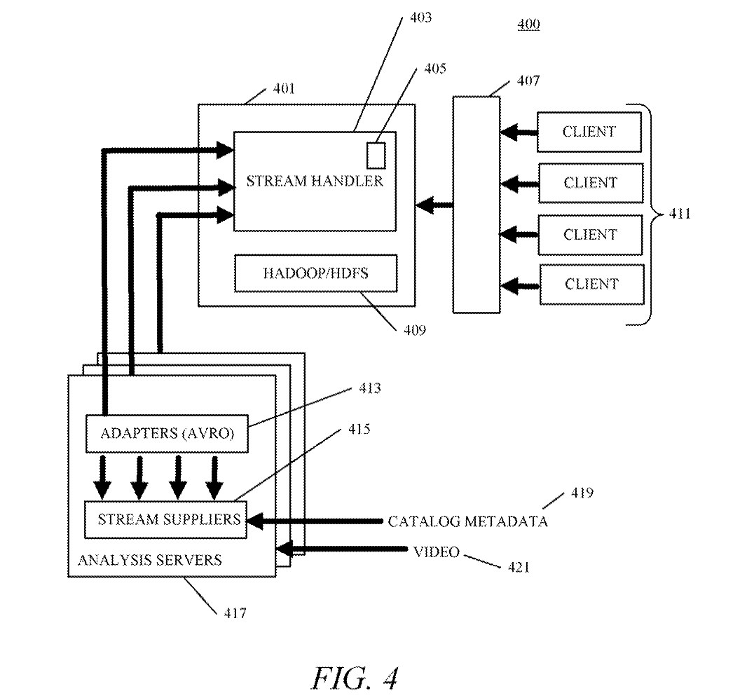

FIG. 4 provides another example embodiment where a stream handler 403 is included in a distributed file system 401. The stream handler 403 includes a correlation engine 405. The distributed file system may be for example a HADOOP/HDFS based distributed file system 409 in accordance with one embodiment. As shown in FIG. 4 catalog metadata 419 and primary content such as video 421 may be utilized by stream suppliers 415 in conjunction with analysis servers 417. The plurality of stream suppliers 415 may provide data to the distributed file system 401 via, for example, AVRO adapters 413 to provide for simple integration in reading and writing of data files between the stream suppliers 415 and the distributed file system 401. In other words the AVRO adapters allow for the file schema to be stored along with the file within the distributed file system 401 so that any of the clients 411 can access to the files by using the defined schema. That is, the schema associated with each stored file may be present within each file stored within the distributed file system 401. As understood by those of ordinary skill, the AVRO schema may be defined using for example, JavaScript Object Notation (JSON). However, other file schemas using other data interchange formats may be used in the various embodiments. Similar to the example embodiment discussed with respect to FIG. 1, the plurality of clients 411 access the distributed file system 401 by access network 407 to facilitate communication with the correlation engine 405 which is contained within the stream handler 403.

Given that catalog metadata 419 exists, “sub-program” catalog metadata and/or other meta-content elements, can be added to the distributed file system 401 by the stream suppliers 415. For example, turning to FIG. 3, authored meta-content elements 309 may be created using a meta-content authoring console (i.e. an authoring “client application” or “tool”), which may provide an operator with the ability to manually generate meta-content elements. Likewise, analyzed meta-content 311 may be created via a catalog metadata or meta-content analyzer, which may be located on the analysis servers 417 shown in FIG. 4. Such analyzers may be one of a family of client applications or tools capable of processing primary content such as audiovisual content referred to in a catalog metadata repository, and generating fine-grained descriptors on a specific domain and associated with a given time within the duration of the a primary content or meta-content element. Examples include, but are not limited to, close-captioned generators and scene change detectors.

Such analyzers may also provide suggestions to the meta-content authoring console mentioned above, in order to assist the manual generation of meta-content elements. In one example, an operator may use a meta-content authoring console to manually enter editorial information on a primary content. If the primary content is a movie, the operator might enter the editorial information for all the scenes in the movie, and scene segmentation information may be automatically extracted by a meta-content analyzer and provided to the meta-content authoring tool. The information may be presented to the operator via a user interface, to help guide the manual editing of, for example, catalog metadata for each scene of the movie.

For purposes of the example of FIG. 3 and FIG. 4, meta-content elements are shown as “streams” (or meta-content streams) such as multimedia streams, closed captioning, and other real-time text, etc. It is to be understood that this example is helpful for explaining the features and advantages of the various embodiments, but that the various embodiments are not limited to such “streams.” In the FIG. 3 example, the stream and configuration repository 307 stores meta-content elements (i.e., streams, in this example) associated with various pieces of primary content. The streams may be generated and added to the stream and configuration repository 307 by either an authoring tool or a meta-content analyzer as follows. Either an authoring tool or a meta-content analyzer, of stream suppliers 301, may access the stream interface 325 to request the creation of a new stream of a given domain type for a given primary content, such as an audiovisual content, or to open an existing stream of the given domain type for that primary content. The stream interface 325 may access the stream and configuration repository 307 via a configuration manager 323 of the access control manager 317. The access control manager 317 may include several modules, such as a policy manager 319, a privacy manager 321, and the configuration manager 323. The policy manager 319 may determine whether the entity requesting access has authorization to access the requested meta-content and has permission to perform various usage activities such as, but not limited to, viewing, analyzing, editing, etc. The privacy manager 321 may access user histories, and/or user profiles that contain user specific information. For example, the various stream suppliers 301 may have tools such as the authoring tool example provided above, that has an associated user history and/or user profile. The privacy manager 321 may restrict or prohibit certain information from being collected into metadata or meta-content, where that information is related to the user and the user's access to primary content or meta-content. In embodiments having a privacy manager 321, the privacy manager works with the access control manager 317 policy manager 319, to ensure that users who require no data collection in their context are not shown or provided primary content or meta-content, where a usage policy for that primary content or meta-content requires data collection from the user in order to be consumed. In other words, some primary content and/or meta-content authors or owners may set usage policies where a set of conditional rules require certain types of information to be collected from the users. Because such information collection may not be appropriate for certain users, the privacy manager 321 may, in some embodiments, block content and/or meta-content for those specific users.

Assuming a stream of the requested type exists for the request, the configuration manager 323 may return a handle for the requested meta-content stream to the stream interface 325. If a stream of the requested type does not exist for the indicated primary content, the access control manager 317 may confer permission to create a meta-content stream of the given type in the stream and configuration repository 307, and the configuration manager 323 may associate it to with the primary content using the primary content's unique identifier, returning a handle to the new empty stream to the stream interface 325. The configuration manager 323, in some embodiments, may retain a header with information on every stream present in the stream and configuration repository 307. The header may include information such as, but not limited to, a primary content identifier such as an audiovisual content identifier, catalog metadata domain type, primary content duration, time units for the particular catalog metadata stream, and stream handle, etc. Once the stream interface 325 has a stream handle, it can makes it available to the stream suppliers 301 for use by, for example, a meta-content analyzer or a meta-content authoring console to be embedded in future read or write requests from those modules to the stream and configuration repository 307. Likewise, once meta-content is available for a given primary content and domain type, it is made available and accessible for read and write operations based on policy (via policy manager 319 and privacy manager 321) to external applications via, for example, secure and access-controlled connections.

In the FIG. 3 example, requests to read or write meta-content are made through the stream interface 325. The stream interface 325 handles stream writes by supporting typical list data structure operations such as insert, add, and delete. Write requests also include the stream handle, the desired insertion point in the stream (sequentially at the end or by specific index number), and the meta-content element to be inserted at the requested insertion point. Meta-content elements may include, among other things, a start time unit, an end time unit, a placement index, and a desired annotation.

Read requests may be handled by the stream interface 325 using a variety of methods. A request for a meta-content steam will indicate the stream handle along with other information. For example, an entire meta-content stream may be requested, in which case a suitable representation of a list of all catalog metadata nodes will be returned. Catalog metadata at a given index may be requested, in which case a suitable representation of a single catalog metadata node will be returned. Catalog metadata within a given index range may be requested, in which case a suitable representation of a list encompassing multiple catalog metadata nodes will be returned. Catalog metadata at a given normalized time or time range may be requested, in which case the stream interface 325 may access the correlation engine 327 which may compute an equivalent index or index range with respect to the current meta-content stream based on a normalized time for the main instance of the primary content, resulting in the system returning a suitable representation of a list encompassing multiple catalog metadata nodes.

In the case of requests where more than one catalog metadata node is returned, the request must also indicate if the returned content is expected all at once, synchronized in time as a pushed event (delivering only on-time nodes), or synchronized in time as a pulled event (delivering only on-time nodes).

The stream interface 325 may also handle read requests where more than one, or potentially all, meta-content streams related to a primary content are required. In this case, the stream interface 325 receives a request that indicates the primary content identifier and the domain types of meta-content streams desired, along with the return mode. This return mode can be all at once, synchronized in time as a pushed event (delivering only on-time nodes), synchronized in time as a pulled event (delivering only on-time nodes) or synchronized in space (delivering only nodes physically near the client). The stream interface 325 will also receive, as part of the request, an indication as to whether the entire meta-content streams are sought or the time interval or intervals where information synchronized from multiple streams is desired. The stream interface 325 will process these requests through the correlation engine 327 which aggregates the requested data according to the specified parameters and provides it back to the stream interface 325 to be processed by any of the requesting clients.

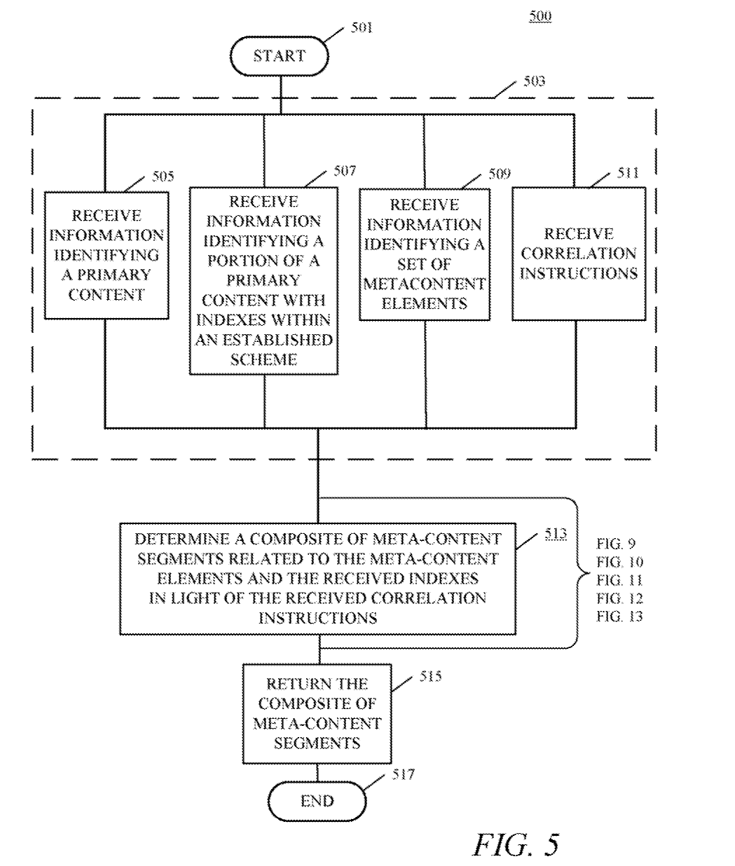

FIG. 5 provides a method of operation 500 of the correlation engine in accordance with one embodiment. The method of operation 500 as shown, begins in 501 were the correlation engine may receive a request 503 from a client application that interacts with the correlation engine to obtain results related to primary content. The request 503 may also be related to meta-content elements, or may be for the purpose of obtaining information related to the meta-content elements themselves. The request 503 includes correlation instructions 511, and may also include information identifying primary content 505, information identifying a portion of the primary content including indexes having an established scheme 507, and/or information identifying a set of meta-content elements 509. In other words the correlation engine will receive correlation instructions 511 and possibly other information identifying content or meta-content, and possibly providing index information. As shown in block 513, the correlation engine may determine a composite of meta-content segments related to the meta-content elements, and any received index information, based on the received correlation instructions 511. The correlation engine will then return the composite meta-content segments at 515 which ends the method as shown in block 517.

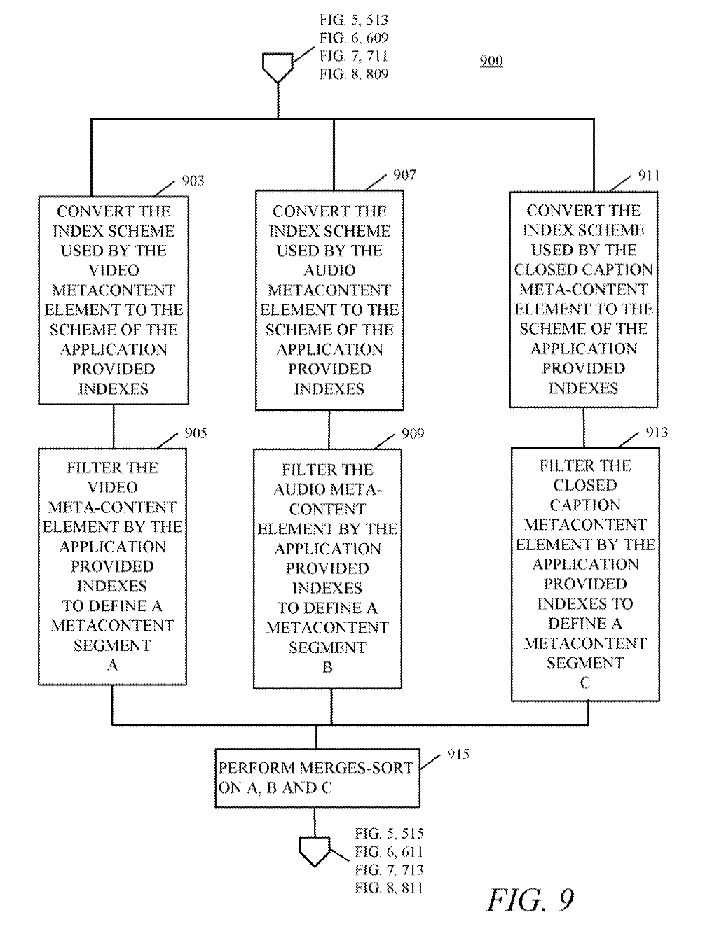

Block 513 represents the determination performed by the correlation engine and may include any of a variety of determinations based on various correlation instructions received in the request 503. Examples of such determinations are provided in FIG. 9 through FIG. 13 which are discussed below.

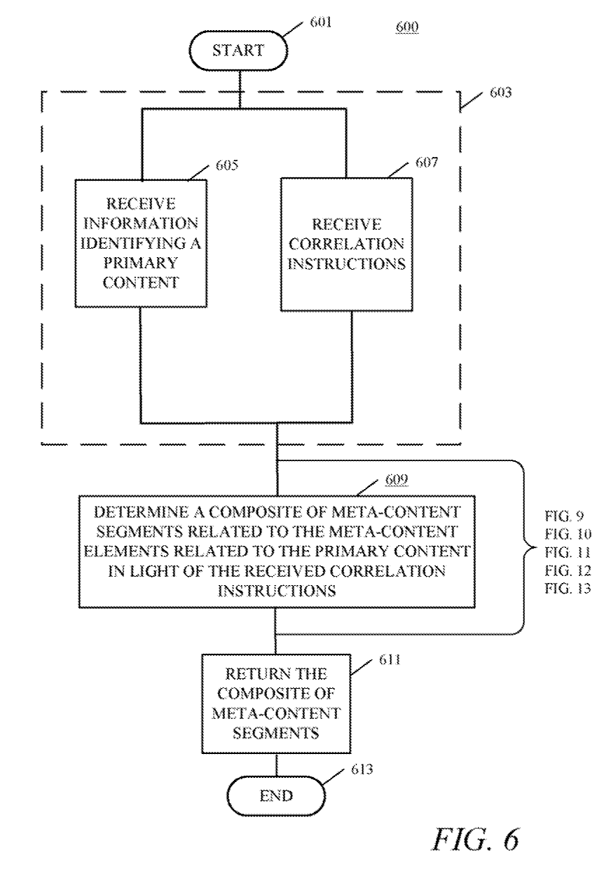

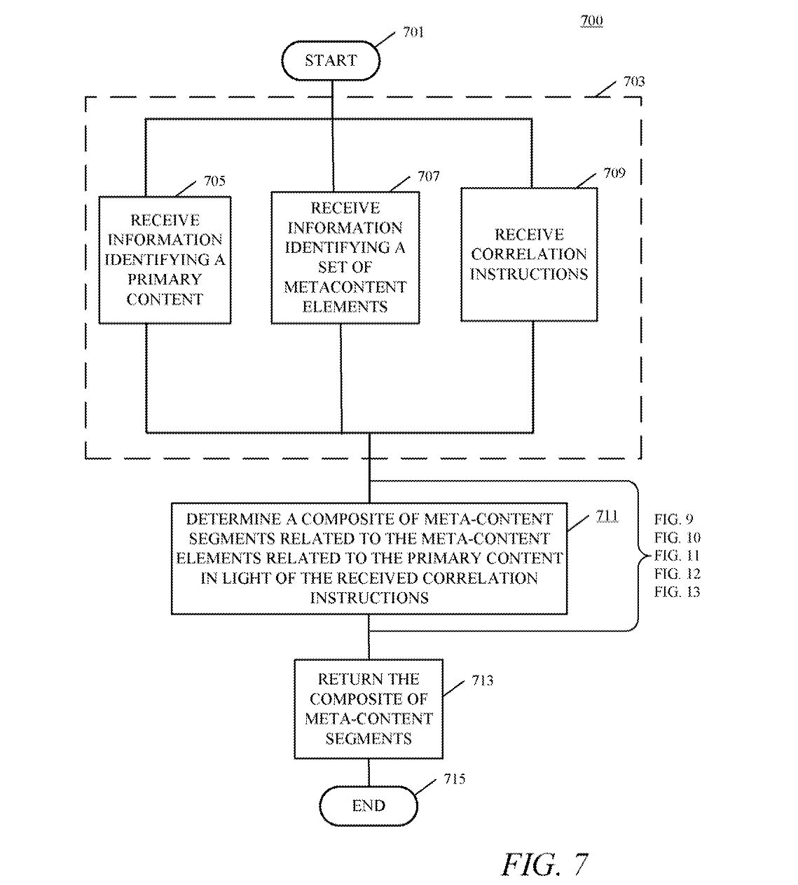

FIG. 6 and FIG. 7 are for the purpose of illustrating that the request (FIG. 6, 603 and FIG. 7, 703) may contain less than the information shown in the request 503 illustrated in FIG. 5. For example, in the FIG. 6 method 600 which begins at 601, the request 603 consists of correlation instructions 607 and information identifying a primary content 605. In response to the request 603, the correlation engine will determine the composite meta-content segments related to the meta-content elements related to the primary content based on the received correlation instructions as shown in block 609. The correlation engine returns a composite of meta-content segments in 611 as the result, and the process ends at block 613.

In FIG. 7, the method 700 begins in 701 and illustrates that a request 703 may include correlation instructions 709, information identifying a primary content 705 and information identifying a set of meta-content elements 707. In some embodiments, a client application will send only correlation instructions to the correlation engine. In other words “request” as used herein may refer to the correlation instructions alone, or may refer to the correlation instructions in combination with other information identifying primary content and/or meta-content. That is, a request is used herein requires at least correlation instructions being sent from a client application to the correlation engine in accordance with the embodiments. In the example method 700, block 711, the correlation engine determines a composite of meta-content segments, related to the meta-content elements, and further related to the primary content based on the correlation instructions 709. The correlation engine returns a composite of meta-content segments in 713 and stops in 715.

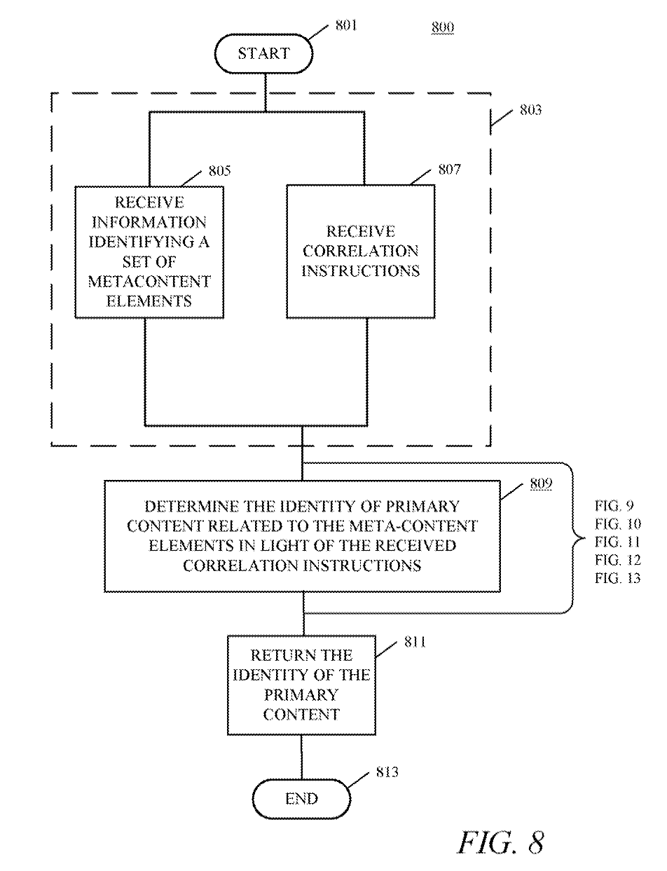

FIG. 8 illustrates a method 800, which begins in 801, and where the correlation engine determines the identity of a primary content related to meta-content elements and based on the correlation instructions as shown in block 809. The request 803 includes correlation instructions 807 and information identifying a set of meta-content elements 805. The correlation engine returns the identity of the primary content as shown in block 811 and the method ends at 813 as shown.

FIG. 9 is a flowchart of a method 900 that is an example of the determine step of FIG. 5, 513; FIG. 6, 609; FIG. 7, 711; and FIG. 8, 809, when the correlation instructions require a time related information aggregation. For example, a client application may request to receive the video, audio and closed caption analysis results, related to a primary content and merged and ordered in time. In block 903, the correlation engine may convert an index scheme used by a video meta-content element to an index scheme provided by the client application in the request. As shown in 905, the correlation engine may filter the video meta-content element using the application provided indexes to define a meta-content segment “A.” The correlation engine will also perform operations related to the audio and closed-captioned portions in accordance with the present example. Therefore, in block 907, the correlation engine may convert the index scheme used by the audio meta-content element to the index scheme provided by the client application, and filter the audio meta-content element using the appropriate indexes to define the meta-content segment “B” as shown in block 909.

The correlation engine will perform similar operations on the close caption indexing as shown in block 911, and perform appropriate filtering on the closed-captioned meta-content element as shown in block 913 to define a meta-content segment “C.” As shown in block 915, the correlation engine may perform a merges-sort operation on meta-content segments A, B and C. The method may then return to any of FIG. 5, 515; FIG. 6, 611; FIG. 7, 713 or FIG. 8, 811 as appropriate when applicable.

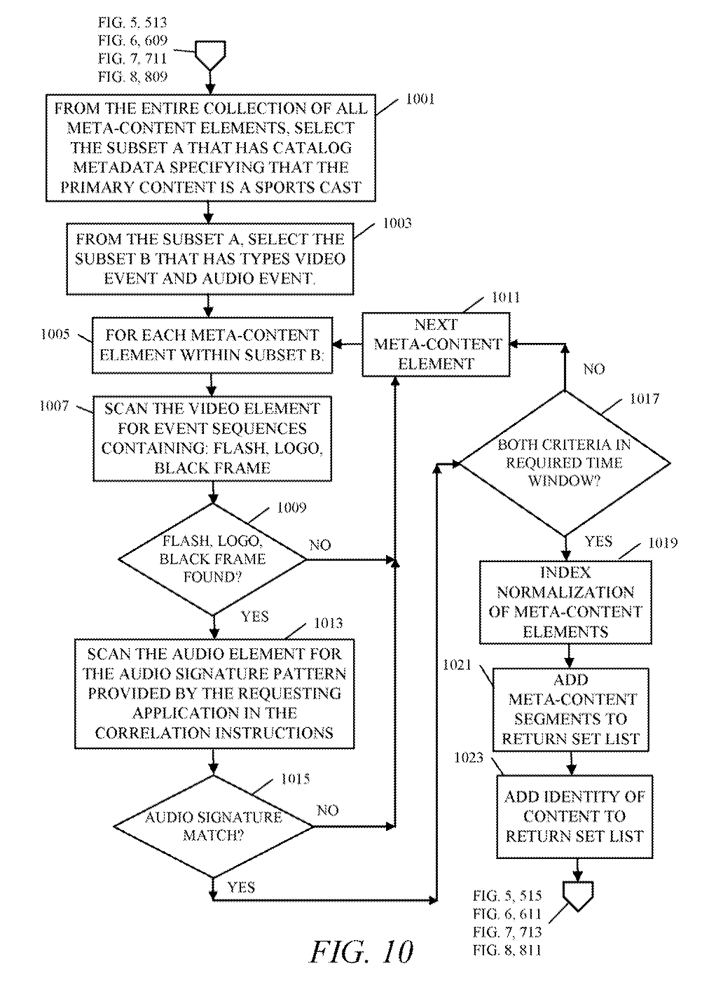

FIG. 10 provides an example of the determine step (FIG. 5, 513; FIG. 6, 609; FIG. 7, 711 or FIG. 8, 809) when the correlation instructions require search against items within meta-content elements. For example, the client application may request to search all video analysis results with a video event sequence of flash frame, logo detection, and/or black frame in that particular order. The application request may further require a search for audio events where the audio event is a station identifier musical signature. In one example, the musical signature may be indicative of a change of scene for replays in sports or commercial breaks. Therefore in 1001, the correlation engine may select a subset of meta-content elements “A,” that has catalog metadata specifying that the primary content is a sportscast. As shown in 1003, the correlation engine may perform a filtering operation by selecting a subset “B,” from the subset A, that has meta-content element types including video events and audio events. The correlation engine may then perform a loop operation related to the subset B as illustrated beginning in block 1005. That is, the correlation engine may scan the video element for event sequences containing the flash, logo, and black frame as shown in 1007. If the required event sequences are found as shown in 1009, the correlation engine may perform the next operation of scanning the audio elements for the audio signature pattern provided by the requesting application as defined in the correlation instructions. This operation is illustrated by block 1013. If an audio signature match is found as shown in block 1015, the correlation engine may determine whether both criteria are within a required time window as shown in block 1017. If any of the criteria as defined by the decision blocks 1009, 1015, or 1017 are not found, the correlation engine may jump to the next meta-content element as shown in block 1011 of the loop operation. However, if all criteria are met at the decision block 1017, then the correlation engine may perform an index normalization of the meta-content elements as illustrated in block 1019. The correlation engine may then add the meta-content segments to the return set list is illustrated in block 1021, and add the identity of the primary content to the return set list as illustrated in block 1023. The method then may continue and return to any of FIG. 5, 515; FIG. 6, 611; FIG. 7, 713 or FIG. 8, 811 as appropriate when applicable.

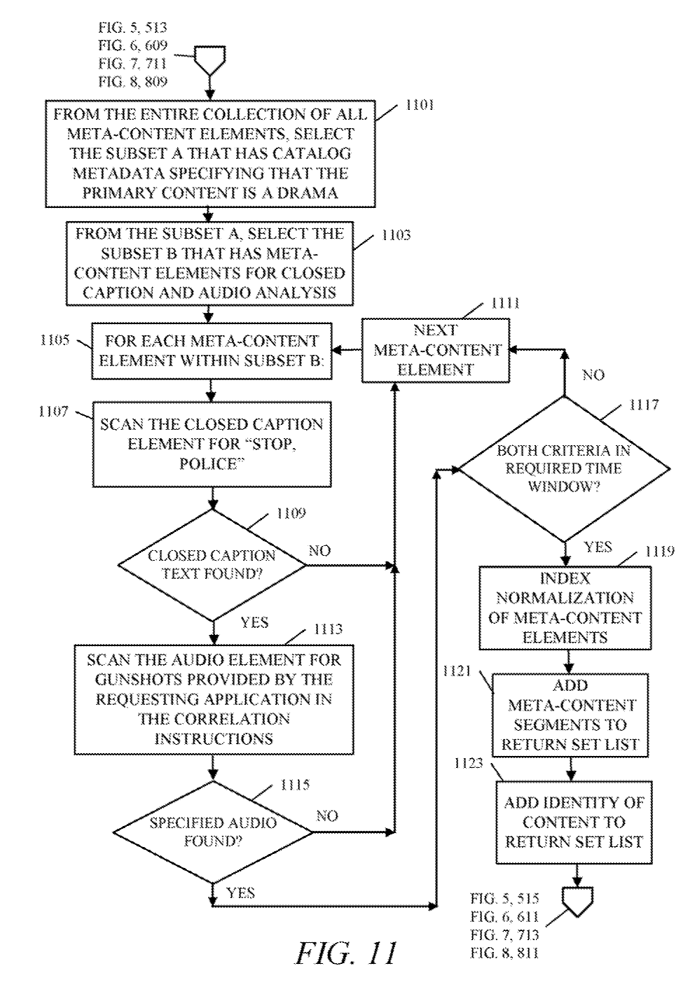

FIG. 11 provides an example of the determine step (FIG. 5, 513; FIG. 6, 609; FIG. 7, 711 or FIG. 8, 809) when the correlation instructions state that a search against items within the meta-content elements is required. For example, a search requested by the application may require searching closed-captioned analysis results containing the words “stop, police” near in time to audio analysis results containing gunshots related to drama shows. Therefore, in 1101, the correlation may engine may select from the entire collection of all meta-content elements subset “A” that has catalog metadata specifying that the primary content is a drama. As shown in 1103, the correlation engine may filter subset A to select a subset “B” that has meta-content elements for closed-caption and audio analysis. The correlation engine may then enter a loop operation related to the meta-content element subset B as shown starting in block 1105. That is, the correlation engine may scan the closed-caption meta-content elements for the required words “stop, police” as shown in 1107. If the required closed-caption text is found as shown in decision block 1109, the correlation engine may scan the audio meta-content element for the required gunshot audio signature as provided by the requesting application, and defined in the correlation instructions, as shown in block 1113. If the specified audio is found as illustrated in decision block 1115, the correlation engine may check that both criteria occur within a required time window as illustrated by decision block 1117. If any of the criteria required in decision blocks 1109, 1115, or 1117 are not found, the correlation engine will jump to the next meta-content element as shown in block 1111 of the loop operation. Assuming that all the criteria are found and satisfied as required by decision block 1117, the correlation engine may perform an index normalization of the meta-content elements as shown in block 1119, and add the meta-content segments to the return set list as illustrated in block 1121. The correlation engine may add the identity of the primary content to the return set list as shown in block 1123. The method then may continue and return to any of FIG. 5, 515; FIG. 6, 611; FIG. 7, 713 or FIG. 8, 811 as appropriate when applicable.

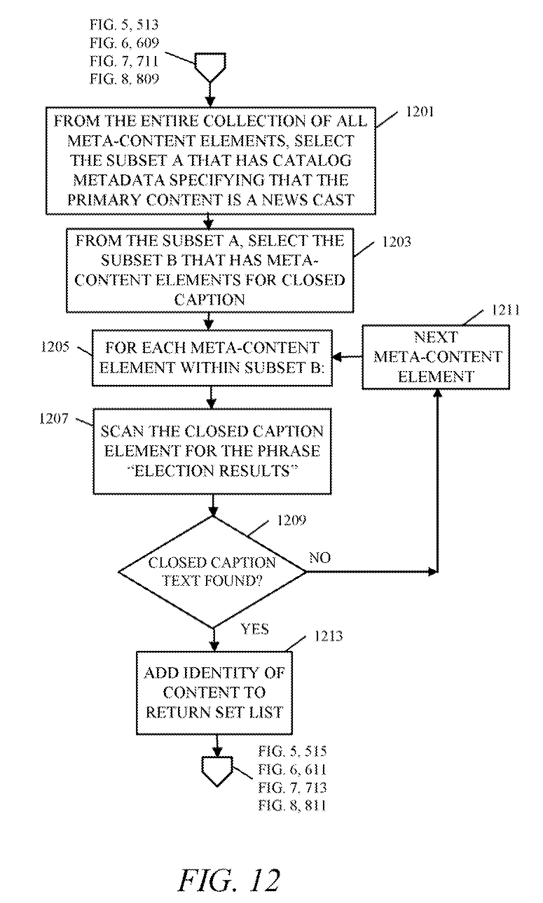

FIG. 12 illustrates an example of the determine step (FIG. 5, 513; FIG. 6, 609; FIG. 7, 711 or FIG. 8, 809) when the correlation instructions state that a search against items within meta-content elements should search all closed-caption analysis results related to a newscast containing the words “election results.” For example, in 1201, the correlation engine may create a subset “A” of all meta-content elements that have catalog metadata specifying that the primary content is a news cast. The correlation engine may then perform the filtering operation as illustrated in block 1203. In block 1203, the correlation engine may select a subset “B” that has meta-content elements for closed captioning. The correlation engine may then perform a loop operation related to the meta-content elements within subset “B” as illustrated beginning in block 1205. As shown in block 1207, the correlation engine may scan for closed-captioned elements that contain the phrase “election results.” If the closed-captioned text is found, as illustrated in decision block 1209, the correlation engine may add the identity of the primary content to the return set list as illustrated in block 1213. Otherwise, the method proceeds to the next meta-content element as shown in 1211. After block 1213, the method may continue and return to any of FIG. 5, 515; FIG. 6, 611; FIG. 7, 713 or FIG. 8, 811 as appropriate when applicable.

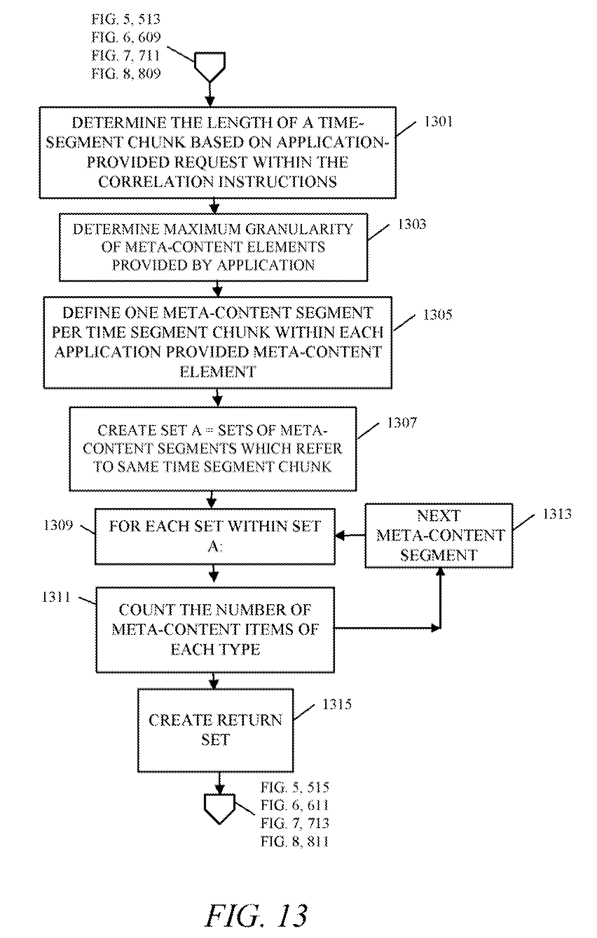

FIG. 13 provides an example of the determine step (FIG. 5, 513; FIG. 6, 609; FIG. 7, 711 or FIG. 8, 809) when the correlation instructions require the construction of a “heat map” against either simple counts or complex aggregated statistics of meta-content items within a conjoint grouping of meta-content elements. For example, the application may request type-keyed counts of meta-content items versus time-segmented chunks of primary content. Therefore, in block 1301 the correlation engine may determine the length of a time-segmented chunk based on application provided correlation instructions sent in the request. In 1303, the correlation engine may determine the maximum granularity of meta-content elements as defined in the request provided by the application. In block 1305, the correlation engine may define one meta-content segment per time segment chunk within each application provided meta-content element. In 1307, the correlation engine may create a set “A,” which includes all meta-content segments which refer to the same time segment chunk. The correlation engine may then enter a loop operation with respect to the defined set A as shown beginning in 1309. The correlation engine, as shown in block 1311, may count the number of meta-content items of each type, and create a return set as shown in block 1315. The correlation engine will perform the count operation for each meta-content element in the loop operation as illustrated by block 1313. The method then may continue and return to any of FIG. 5, 515; FIG. 6, 611; FIG. 7, 713 or FIG. 8, 811 as appropriate when applicable.

In accordance with the embodiments, the correlation engine, and also the stream interface and access control manager, may be implemented in various ways. For example, the correlation engine, stream interface and/or access control manager may be implemented as software and/or firmware executing on one or more programmable processors, ASICs, DSPs, hardwired logic or combinations thereof. In the example of FIG. 1, the correlation engine 101 may be considered to be software and/or firmware executing on one or more processors of a server. The one or more processors, is operatively coupled to non-volatile, non-transitory memory and the one or more processors may communicate with the memory as required to execute the executable instructions of the software and/or firmware stored therein, to perform the methods and operations described herein, in accordance with the various embodiments.

Therefore, another aspect of the various embodiments is a computer readable medium, in other words a non-volatile, non-transitory memory storing executable instructions for execution by at least one processor. The at least one processor, when executing the executable instructions is thus operative to perform the methods and operations described herein, in accordance with the various embodiments.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

1. A method comprising:
receiving, by a correlation engine, correlation instructions related to a plurality of meta-content elements, the meta-content elements associated with a primary content;
performing, by the correlation engine, a correlation in response to receiving the correlation instructions, the correlation being between the meta-content elements, the meta-content elements each having an arbitrary granularity defining meta-content segments of the meta-content elements; and
returning, by the correlation engine, a result based on the correlation.

2. The method of claim 1, where returning the result based on the correlation comprises:
returning at least one meta-content segment.

3. The method of claim 1, comprising:
receiving a request from a client application, the request including the correlation instructions.

4. The method of claim 1, comprising:
adjusting the arbitrary granularity of each meta-content element to a uniform granularity, prior to performing the correlation.

5. The method of claim 1, comprising:
normalizing an arbitrary index of each meta-content element to create a normalized index between the plurality of meta-content elements, prior to performing the correlation.

6. The method of claim 1, comprising;
performing the correlation based on at least one of a time based index, a location based index, or a context based index.

7. The method of claim 3, wherein receiving a request from a client application, the request including the correlation instructions, comprises:
receiving information identifying the primary content.

8. The method of claim 3, wherein receiving a request from a client application, the request including the correlation instructions, comprises:
receiving information identifying a set of meta-content elements associated with the primary content.

9. The method of claim 3, wherein receiving a request from a client application, the request including the correlation instructions, comprises:
receiving information identifying a portion of the primary content with indexes according to an established indexing scheme.

10. A method comprising:
receiving, by a correlation engine, a request having correlation instructions related to a plurality of meta-content elements, the meta-content elements associated with a primary content, each meta-content element having an arbitrary granularity defining meta-content segments of the meta-content elements;
determining, by the correlation engine, in response to receiving the request, a composite of meta-content segments of the plurality of meta-content elements, based on the correlation instructions.

11. The method of claim 10, comprising:
performing a correlation in response to the request, the correlation being between the meta-content elements based on an indexing scheme, each meta-content element having an arbitrary indexing scheme.

12. The method of claim 11, comprising:
adjusting the arbitrary granularity of each meta-content element to a uniform granularity, prior to performing the correlation; and
normalizing each meta-content element arbitrary indexing scheme to create a normalized index between the plurality of meta-content elements, prior to performing the correlation.

13. The method of claim 12, comprising:
normalizing each meta-content element arbitrary indexing scheme to create the normalized index where the normalized index includes at least one of a time based index, a location based index, or a context based index.

14. A method comprising:
receiving, by a correlation engine, a request having correlation instructions related to a plurality of meta-content elements, the meta-content elements associated with a primary content, each meta-content element having an arbitrary granularity defining meta-content segments of the meta-content elements;
performing, by the correlation engine, in response to the request, a correlation between the meta-content elements based on an indexing scheme, each meta-content element having an arbitrary indexing scheme; and
determining, by the correlation engine, an identity of the primary content based on the results of the correlation.

15. The method of claim 14, comprising:
adjusting the arbitrary granularity of each meta-content element to a uniform granularity, prior to performing the correlation; and
normalizing each meta-content element arbitrary indexing scheme to create a normalized index between the plurality of meta-content elements, prior to performing the correlation.

16. The method of claim 15, comprising:
normalizing each meta-content element arbitrary indexing scheme to create the normalized index where the normalized index includes at least one of a time based index, a location based index, or a context based index.

17. An apparatus, comprising:
at least one programmable processor; and
memory, operatively coupled to the programmable processor, containing executable instructions for execution by the at least one processor, where the at least one processor, upon executing the executable instructions is operable to:
receive correlation instructions related to a plurality of meta-content elements, the meta-content elements associated with a primary content;
perform a correlation in response to receiving the instructions, the correlation being between the meta-content elements, the meta-content elements each having an arbitrary granularity defining meta-content segments of the meta-content elements; and
return a result based on the correlation.

18. The apparatus of claim 17, where the at least one programmable processor, upon executing the executable instructions is operable to:
adjust the arbitrary granularity of each meta-content element to a uniform granularity;
normalize an arbitrary indexing scheme of each meta-content element to create a normalized index between the plurality of meta-content elements; and
perform the correlation based on the correlation instructions, the correlation being between the meta-content elements based on the normalized index.

19. The apparatus of claim 17, where the at least one programmable processor, upon executing the executable instructions is operable to:
determine, based on the correlation, a composite of meta-content segments of the plurality of meta-content elements, and return as the result the composite of meta-content segments.

20. The apparatus of claim 17, where the at least one programmable processor, upon executing the executable instructions is operable to:
determine an identity of the primary content based on the correlation.
